(19) United States
(12) Patent Application Publication
(10) Pub. No.: US 2009/0128396 A1
(43) Pub. Date: May 21, 2009

(54) Filling Level Sensor for Short Measuring Distances

(76) Inventors: Josef Fehrenbach, Haslach i. K. (DE); Karl Griessbaum, Muhlenbach (DE); Klaus Kienzle, Zell (DE); Daniel Schultheiss, Hornberg (DE)

Correspondence Address: FAY KAPLUN & MARCIN, LLP, 150 BROADWAY, SUITE 702, NEW YORK, NY, 10038, US

(21) Appl. No.: 12/251,989

(22) Filed: Oct. 15, 2008

Related U.S. Application Data
(60) Provisional application No. 60/988,956, filed on Nov. 19, 2007.

(30) Foreign Application Priority Data
Nov. 19, 2007 (EP) 07 120 998.5

(51) Int. Cl. G01S 13/08; G01F 23/00

(52) U.S. Cl. 342/124

(57) ABSTRACT

A filling level sensor for a short distance measurement includes a first antenna transmitting a transmission signal to a material surface; a second antenna receiving a reception signal reflected by the material surface; and a common outer enclosure enclosing the first antenna and the second antenna.

### PRIORITY CLAIM

This application claims the benefit of the filing date of European Patent Application Serial No. 07 120 998.5 filed Nov. 19, 2007 and U.S. Provisional Patent Application Ser. No. 60/988,956 filed Nov. 19, 2007, the disclosure of which applications is hereby incorporated herein by reference.

### FIELD OF INVENTION

The present invention pertains to filling level measurements. The present invention specifically pertains to a filling level sensor for short distance measurements, to an antenna system for a filling level sensor, to the utilization of a filling level sensor for filling level measurements and to the utilization of an antenna system for filling level measurements.

### BACKGROUND INFORMATION

Due to their design, conventional filling level measuring devices have an inferior accuracy at shorter distances from the material surface (up to approximately 1.5 m) than at distances of more than 2 m from the material surface. These inaccuracies may be caused, for example, by so-called antenna ringing that consists of multiple reflections between the high-frequency module, the antenna coupling and the antenna edge. These reflections extend into the measuring range of the sensor and cause interferences with a reflection or an echo of a material surface in this measuring range or even reduce the measuring sensitivity for minor reflections from the material surface. This is also referred to as a “dead range,” in which it may be very difficult or even impossible for the sensor to detect echoes.

Known radar sensors for filling level measurements feature a common antenna for the transmitter and the receiver. In such sensors, a finite reflection loss of the antenna or the antenna coupling between the high-frequency module and the antenna may result in a so-called dead range, in which not only the sensitivity may substantially be reduced, but the measuring accuracy may also be significantly lowered due to interferences between the reflections of the antenna system and the reflections of the material surface.

### SUMMARY OF INVENTION

The present invention relates to a filling level sensor for short distance measurements, an antenna system for a filling level sensor, the utilization of a filling level sensor for filling level measurements, as well as the utilization of an antenna system for filling level measurements.

According to one exemplary embodiment of the present invention, a filling level sensor for short distance measurements is disclosed that features a first antenna for transmitting a transmission signal to a material surface, a second antenna for receiving the reception signal reflected by the material surface and a common outer enclosure for the first and the second antenna.

This may provide for an improved close-range measuring quality of a filling level sensor.

Due to a significantly reduced “dead range,” such a filling level sensor is particularly suitable for accurate measurements in the close range and therefore can also be used in small containers.

Due to the integration of two antennas into a common “outer enclosure” or a common housing or due to two antennas with a common outside contour, a compact design is realized that also fits through small container openings.

According to another exemplary embodiment of the present invention, the common outer enclosure is realized in the form of a housing that is designed for accommodating the first and the second antenna.

The stability of the antenna system of the sensor may be increased in this fashion.

The common outer enclosure may be manufactured, for example, of a plastic. If PTFE (polytetrafluor ethylene) is used, a very high chemical resistance may be achieved.

According to another exemplary embodiment of the present invention, the common outer enclosure and the housing, respectively, has a round, elliptical or angular base.

For example, the base of the common outer enclosure or of the housing is adapted to the aperture cross section of the two antennas. If the two antennas respectively have, for example, a semicircular aperture cross section, the base of the outer enclosure may be realized circular or, for example, even elliptical.

Due to the semicircular aperture cross section of the two antennas, the base of the outer enclosure is optimally utilized. A larger aperture cross section of the antennas may result in a higher directionality (smaller aperture angle) and a higher antenna gain.

According to another exemplary embodiment of the present invention, the first and the second antenna respectively have a round, elliptical or angular aperture cross section.

In addition, the common outer enclosure has, according to another embodiment of the present invention, a cylindrical or conical exterior shape.

According to another exemplary embodiment of the present invention, the first and the second antenna are realized in the form of horn antennas.

Horn antennas may provide the advantage of adequate electric properties such as, e.g., a high aperture efficiency in comparison with other antenna types. This aperture efficiency usually lies at no less than 60%.

According to another exemplary embodiment of the present invention, the first and the second antenna respectively feature an antenna horn with semicircular or semiellipsoidal cross section. This makes it possible to optimally utilize the base of the outer enclosure and a minimal aperture angle or a maximum antenna gain of the antenna can be achieved.

According to another exemplary embodiment of the present invention, the filling level sensor is realized in the form of a filling level radar sensor.

According to another exemplary embodiment of the present invention, an antenna system for a filling level sensor for short distance measurements is disclosed, wherein the antenna system features a first antenna for transmitting a transmission signal to a material surface, a second antenna for receiving a reception signal reflected by the material surface and a common outer enclosure for the first and the second antenna.

The described exemplary embodiments apply likewise to the antenna system, the filling level sensor, as well as the utilization of the antenna system and the filling level sensor for filling level measurements.

According to another exemplary embodiment of the present invention, the antenna system is realized in one piece. The stability of the antenna system may be increased in this fashion.

In addition, this may allow for a simple manufacture, e.g., by means of plastic injection-moulding. Areas that need to be conductive (cone surface of the horn antenna) may be provided with a metal coating.

According to another exemplary embodiment of the invention, the first and the second antenna respectively feature an antenna horn with semicircular or hemiellipsoidal cross section.

According to another exemplary embodiment of the invention, the filling level sensor also features a front antenna cover with an inwardly directed curvature.

According to another exemplary embodiment of the invention, the curvature of the antenna cover is realized conical.

According to another exemplary embodiment of the invention, the antenna system is designed for a flush-front installation into a flange.

According to another embodiment of the present invention, the utilization of an above-described filling level sensor for filling level measurements is disclosed.

According to another embodiment of the present invention, the utilization of an above-described antenna system for filling level measurements is disclosed.

According to another exemplary embodiment of the present invention, the cover of the antenna is, e.g., curved conically inward and its outer rim is provided with a drip edge, at which condensate can accumulate and drip off.

Exemplary embodiments of the invention are described below with reference to the figures.

### BRIEF DESCRIPTION OF DRAWINGS

FIG. 1 shows a radar sensor with separate planar antennas for the transmitter and the receiver.

FIG. 2 shows a schematic representation of two horn antennas according to one exemplary embodiment of the present invention.

FIGS. 3A and 3B show an antenna system with horn antennas that are inclined relative to one another according to another exemplary embodiment of the present invention.

FIGS. 4A and 4B show antenna systems with two half horn antennas according to another exemplary embodiment of the present invention.

FIG. 5 shows an antenna system with two half horn antennas that are arranged directly adjacent to one another according to another exemplary embodiment of the present invention.

FIG. 6 shows an antenna system with two bent horn antennas according to another exemplary embodiment of the present invention.

FIG. 7 shows a schematic cross-sectional representation of an antenna system with two half horns antennas according to another exemplary embodiment of the present invention.

FIG. 8 shows a filling level measuring device or filling level sensor according to another exemplary embodiment of the present invention.

FIG. 9 shows a schematic representation of polarization planes of the transmission and reception signals according to one exemplary embodiment of the present invention.

FIG. 10 shows a schematic representation of polarization planes of the transmission and reception signals according to another exemplary embodiment of the present invention.

FIGS. 11A and 11B show an antenna system with an inwardly curved cover 1101 of the antennas according to another exemplary embodiment of the present invention.

FIG. 12 shows an antenna system with flush-front installation according to another exemplary embodiment of the present invention.

### DETAILED DESCRIPTION

The illustrations shown in the figures are purely schematic and not drawn true-to-scale.

In the following description of the figures, the same reference symbols are used for identical or similar elements.

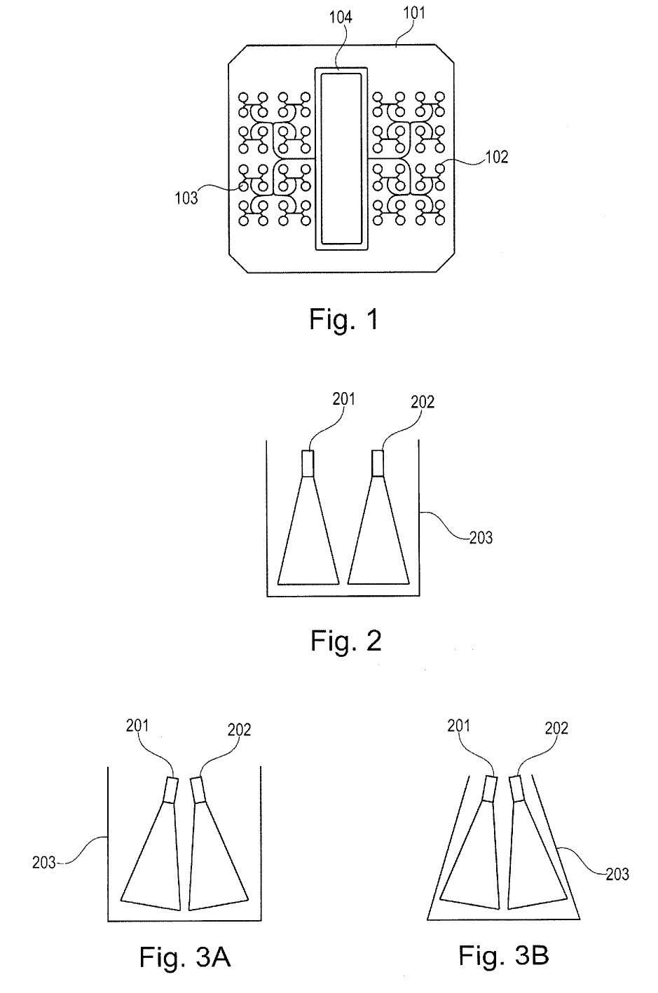

FIG. 1 shows a radar sensor with separate planar antennas 102, 103 for the transmitter and the receiver. The planar antennas 102, 103 are arranged on a printed circuit board 101. An electronics module 104 is also provided.

Since the planar antennas 102, 103 and the microwave circuitry 104 are jointly arranged on the substrate 101, the process temperature inside the container is clearly limited because the electronic components are subjected to the full temperature of the container.

FIG. 2 shows an antenna system with a first horn antenna 201 and a second horn antenna 202 that are arranged adjacent to one another in a common housing 203. In this case, the cross-sectional surfaces of the antenna horns are realized, for example, round or elliptical.

FIG. 3A shows an antenna system according to another exemplary embodiment of the present invention, in which the “normal” horn antennas 201, 202 are inclined relative to one another. The container has, for example, a cylindrical shape, the cross section of which is adapted to the aperture cross sections of the antennas 201, 202.

FIG. 3B shows another exemplary embodiment of an antenna system, in which the two horn antennas 201, 202 are also inclined relative to one another. In this case, the common housing 203 is adapted to the incline of the antennas, for example, it is conically tapered toward the top.

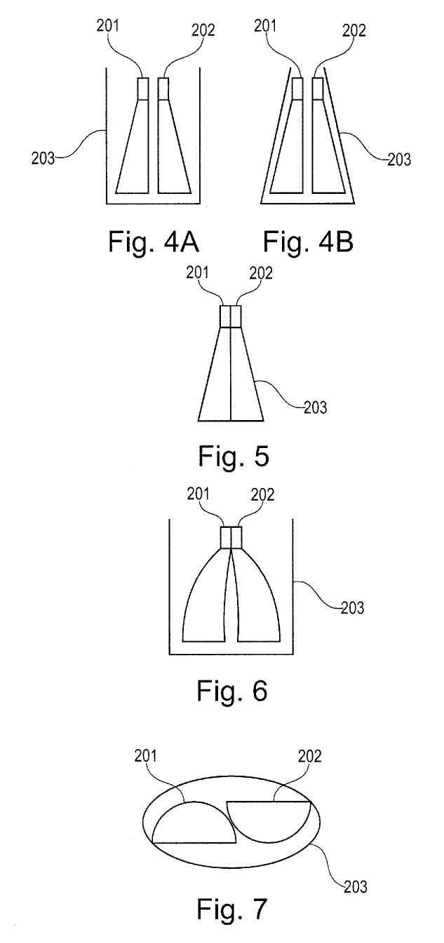

FIG. 4A shows another exemplary embodiment of an antenna system according to the present invention, in which two “half” horn antennas 201, 202 are arranged adjacent to one another in the housing 203. In this case, the housing is realized, for example, with a cylindrical shape.

FIG. 4B shows another exemplary embodiment of the present invention, in which the two “half” horn antennas 201, 202 are also arranged adjacent to one another and also have a semicircular or hemiellipsoidal cross section as in the embodiment according to FIG. 4A. The housing 203 is tapered toward the top and adapted, for example, to the external shape of the horn antennas 201, 202 by having a circular or elliptical cross section.

FIG. 5 shows another exemplary embodiment of an antenna system according to another embodiment of the present invention, in which the two horn antennas 201, 202 are arranged directly adjacent to one another such that they jointly have the exterior shape of a normal horn antenna. In this case, the two horn antennas 201, 202 are realized, for example, with a semicircular or hemiellipsoidal cross section (“half” horn antennas).

FIG. 6 shows an antenna system according to another exemplary embodiment of the present invention, in which the two horn antennas 201, 202 are realized in a bent fashion.

FIG. 7 shows an antenna system according to another exemplary embodiment of the present invention in the form of a bottom view, i.e., a view of the openings of the horn antennas 201, 202. Two “half” horn antennas 201, 202 are provided that respectively have a semicircular or hemiellipsoidal (semiellipsoidal) cross section. The two horn antennas are arranged laterally adjacent and turned relative to one another. The common housing 203 has, for example, an elliptical cross section.

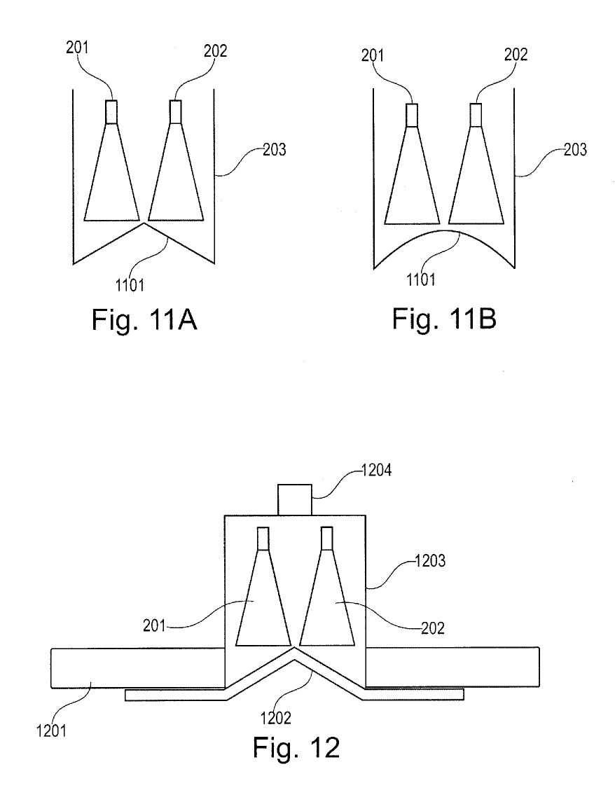

FIGS. 11A and 11B show an antenna system with an inwardly curved cover 1101 of the antennas. Due to this design, condensate collecting on the front cover can run toward and drip off the rim. The curvature 1101 may be realized, for example, conical or round.

In comparison with an outward curvature (e.g., drip-off point in the center), the inward curvature provides the advantage of a significantly higher decoupling of the two antennas (that is approximately 15 dB better).

FIG. 12 shows an antenna system with flush-front installation. In this case, the common housing consists of a flange 1201, a plastic cover 1202 and an encapsulation 1203. The connection piece 1204 forms the connection with the (not-shown) electronics housing.

This embodiment may be particularly suitable for small containers without connection pieces because the sensor does not protrude into the container and thusly further reduce the possible measuring range.

According to the exemplary embodiments of the invention, both horn antennas are jointly arranged adjacent to one another in a housing, for example, of cylindrical, elliptical or conical shape. One preferred solution is the conical antenna housing because the diameter is reduced from the front edge of the antenna toward the antenna connection such that it can be easily connected to already existing electronics housings.

The two antennas may have a round, semicircular, elliptical or angular aperture cross section such that they optimally utilize the surface of the antenna housing that points toward the medium. This makes it possible to achieve the maximum attainable antenna gain and the minimum aperture angle for a given surface.

The advantages can be seen, in particular, in a superior decoupling between the transmission and the reception antenna, a compact design of the antenna system, a small “dead range” and therefore a high accuracy and sensitivity in the close range, as well as a very good suitability for small containers.

Parabolic antennas may also be considered as other antenna shapes.

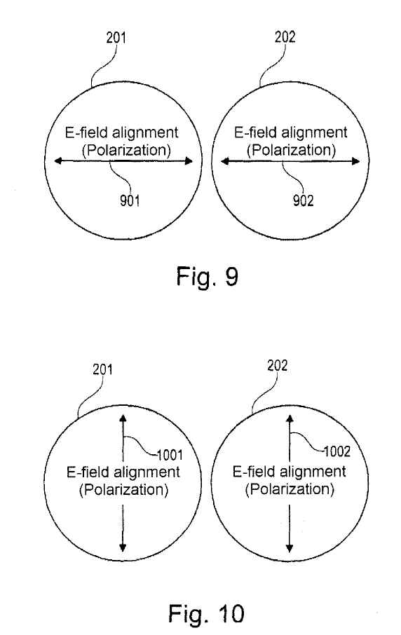

FIG. 9 shows a schematic representation of polarization planes of the transmission and reception signals according to one exemplary embodiment of the present invention.

The reference symbols 901 and 902 respectively show the polarization planes of the electric field of the transmission signal (transmission antenna 201) and the reception signal (reception antenna 202).

FIG. 10 shows a schematic representation of polarization planes of the transmission and reception signals according to another embodiment of the present invention.

The reference symbols 1001 and 1002 respectively show the polarization planes of the electric field of the transmission signal and the reception signal.

In order to additionally improve the decoupling between the transmission and reception units, the polarization planes of the electric field, i.e., the transmission and the reception polarization, can be suitably aligned relative to one another. For example, a parallel alignment of the transmission and the reception polarization is advantageous.

According to FIGS. 9 and 10, the antennas for the transmitter and the receiver have the same polarization planes. In the embodiment according to FIG. 9, the polarization planes 901, 902 lie in a common plane. In the embodiment according to FIG. 10, the polarization planes 1001, 1002 lie in separate, parallel planes that extend perpendicular to a connecting line between the centers of the antennas 201, 202.

The arrangement according to FIG. 10 leads to an improved isolation between the transmission and the reception antenna and therefore also has fewer interfering signals (direct overcoupling from the transmitter into the receiver) in the close range. This increases the measuring sensitivity in this range.

Two horn antennas with a diameter of approximately 18 mm were arranged adjacent to one another and spaced apart by approximately 5 mm in order to carry out comparative tests of the so-called ringing (stray reflections in the close range).

It was determined that measurements up to a distance of a few centimeters from the antenna edge can be carried out with the modified sensor even at very slight echoes. In this case, the reflected signal has an adequate signal-to-noise ratio.

With other antennas, significant interferences that may negatively influence the measuring accuracy may already occur at distances of approximately 20 to 30 cm. At shorter distances, the reflection could hardly be detected any longer or not at all in the antenna ringing.

The decoupling between the two antennas increases proportionally with the distance between the antennas. This significantly reduces the overcoupling between the antennas and therefore the ringing. To this and, two different antenna variations (round horn, semicircular horn) were arranged in different positions relative to one another and the transmission behavior (i.e., the isolation between the transmitter and the receiver) was calculated with a three-dimensional field simulation program and subsequently measured with a vectorial network analyzer.

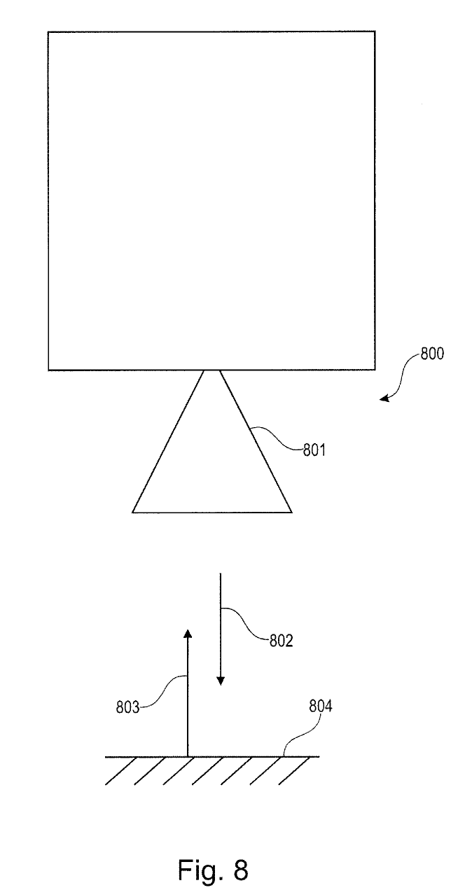

FIG. 8 shows a schematic representation of a filling level radar according to another exemplary embodiment of the present invention.

In this case, the filling level radar 800 features a signal generator unit and a receiving circuit. In addition, an antenna device 801 (antenna system) according to an exemplary embodiment of the present invention is provided.

The antenna system 801 transmits a transmission signal 802 in the direction of the material surface 804, wherein said signal is reflected by the material surface and detected by the antenna system 801 as a reception signal 803. The filling level can be determined thereof.

As a supplement, it should be noted that “comprising” and “featuring” do not exclude other elements or steps and that “a” or “an” does not exclude a plurality. It should furthermore be noted that characteristics or steps that were described with reference to one of the above embodiments can also be used in combination with other characteristics or steps of other above-described embodiments. The reference symbols in the claims should not be interpreted in a restrictive sense.

What is claimed is:

1. A filling level sensor for a short distance measurement, comprising:
a first antenna transmitting a transmission signal to a material surface;
a second antenna receiving a reception signal reflected by the material surface; and
a common outer enclosure enclosing the first antenna and the second antenna.

2. The filling level sensor of claim 1, wherein the common outer enclosure has a shape of a housing which accommodates the first antenna and the second antenna.

3. The filling level sensor of claim 1, wherein the common outer enclosure has one of a round base, an elliptical base and an angular base.

4. The filling level sensor of claim 1, wherein the first antenna and the second antenna respectively have one of a round cross section, an elliptical cross section and an angular aperture cross section.

5. The filling level sensor of claim 1, wherein the common outer enclosure has one of a cylindrical exterior shape and a conical exterior shape.

6. The filling level sensor of claim 1, wherein the first antenna and the second antenna have a horn shape.

7. The filling level sensor of claim 6, wherein the first antenna and the second antenna respectively feature an antenna horn which has one of a semicircular cross section and a hemiellipsoidal cross section.

8. The filling level sensor of claim 1, furthermore comprising:
a front antenna cover having an inwardly directed curvature.

9. The filling level sensor of claim 8, wherein the curvature is realized conical.

10. The filling level sensor of claim 1, wherein the sensor is designed for a flush-front installation into a flange.

11. The filling level sensor of claim 1, wherein the sensor is a filling level radar sensor.

12. An antenna system for a filling level sensor for a short distance measurement, comprising:
a first antenna transmitting a transmission signal to a material surface;
a second antenna receiving a reception signal reflected by the material surface; and
a common outer enclosure enclosing the first antenna and the second antenna.

13. The antenna system of claim 12, wherein the antenna system is realized in one piece.

14. A method, comprising:
determining a filling level measurement using a filling level sensor, the sensor including a first antenna transmitting a transmission signal to a material surface; a second antenna receiving a reception signal reflected by the material surface; and a common outer enclosure enclosing the first antenna and the second antenna.

15. A method, comprising:
determining a filling level measurement using an antenna system, the system including a first antenna transmitting a transmission signal to a material surface; a second antenna receiving a reception signal reflected by the material surface; and a common outer enclosure enclosing the first antenna and the second antenna.
